(19) United States
(12) Patent Application Publication
(10) Pub. No.: US 2015/0163356 A1
(43) Pub. Date: Jun. 11, 2015

(54) TIME STAMPING ENTRIES IN AN ADDRESS BOOK OF A MOBILE COMMUNICATIONS DEVICE

(71) Applicant: INTERNATIONAL BUSINESS MACHINES CORPORATION, Armonk, NY (US)

(72) Inventors: JAVIER A. FIGUEROA, Miramar, FL (US); ADRIAN X. RODRIGUEZ, Durham, NC (US); ERIC WOODS, Durham, NC (US)

(73) Assignee: INTERNATIONAL BUSINESS MACHINES CORPORATION, Armonk, NY (US)

(21) Appl. No.: 14/102,589

(22) Filed: Dec. 11, 2013

(51) Int. Cl. H04M 3/42; H04W 4/12

(52) U.S. Cl. CPC H04M 3/42093; H04W 4/12

(57) ABSTRACT

Administering text message communications, including: maintaining, by a service provider, an account age for a plurality of phone numbers; receiving, by the service provider from a mobile communications device, a text message intended to be delivered to a target device associated with a phone number, the text message including metadata describing an address book age of the phone number in an address book of the mobile communications device; determining, by the service provider, whether the address book age of the phone number is older than an account age of the phone number; and responsive to determining that the address book age information of the phone number is older than the account age of the phone number, performing, by the service provider, one or more message administration actions.

### BACKGROUND OF THE INVENTION

1. Field of the Invention

The field of the invention is data processing, or, more specifically, methods, apparatus, and products for time stamping entries in an address book of a mobile communications device.

2. Description of Related Art

Mobile communications devices are becoming increasingly powerful. As mobile communications devices have become more prevalent, users rely on such mobile communications devices to track contact information for family members, friends, and other contacts. Over time, however, contacts that exist in a mobile communications device may become stale as a contact can change their phone number, email address, or other contact information. As such, the user of a mobile communications device may unintentionally initiate data communications with a phone number that no longer works or with a phone number that no longer belongs to the user's contact. This is especially true for pre-paid phones where a limited number of phone numbers are reused after accounts have been closed.

### SUMMARY OF THE INVENTION

Methods, apparatuses, and products for time stamping entries in an address book of a mobile communications device, including: maintaining, by the mobile communications device for each entry stored in the address book of the mobile communications device, age information for the entry; and initiating, by the mobile communications device, data communications with a device associated with the entry stored in the address book, wherein the data communications include the age information for the entry.

The foregoing and other objects, features and advantages of the invention will be apparent from the following more particular descriptions of example embodiments of the invention as illustrated in the accompanying drawings wherein like reference numbers generally represent like parts of example embodiments of the invention.

### BRIEF DESCRIPTION OF THE DRAWINGS

FIG. 1 sets forth a block diagram of automated computing machinery comprising an example mobile communications device useful in time stamping entries in an address book according to embodiments of the present invention.

FIG. 2 sets forth a flow chart illustrating an example method for time stamping entries in an address book of a mobile communications device according to embodiments of the present invention.

FIG. 3 sets forth a flow chart illustrating an additional example method for time stamping entries in an address book of a mobile communications device according to embodiments of the present invention.

FIG. 4 sets forth a flow chart illustrating an additional example method for time stamping entries in an address book of a mobile communications device according to embodiments of the present invention.

FIG. 5 sets forth a flow chart illustrating an additional example method for time stamping entries in an address book of a mobile communications device according to embodiments of the present invention.

FIG. 6 sets forth a flow chart illustrating an example method for administering text message communications according to embodiments of the present invention.

FIG. 7 sets forth a flow chart illustrating an additional example method for administering text message communications according to embodiments of the present invention.

FIG. 8 sets forth a flow chart illustrating an additional example method for administering text message communications according to embodiments of the present invention.

### DETAILED DESCRIPTION OF EXAMPLE EMBODIMENTS

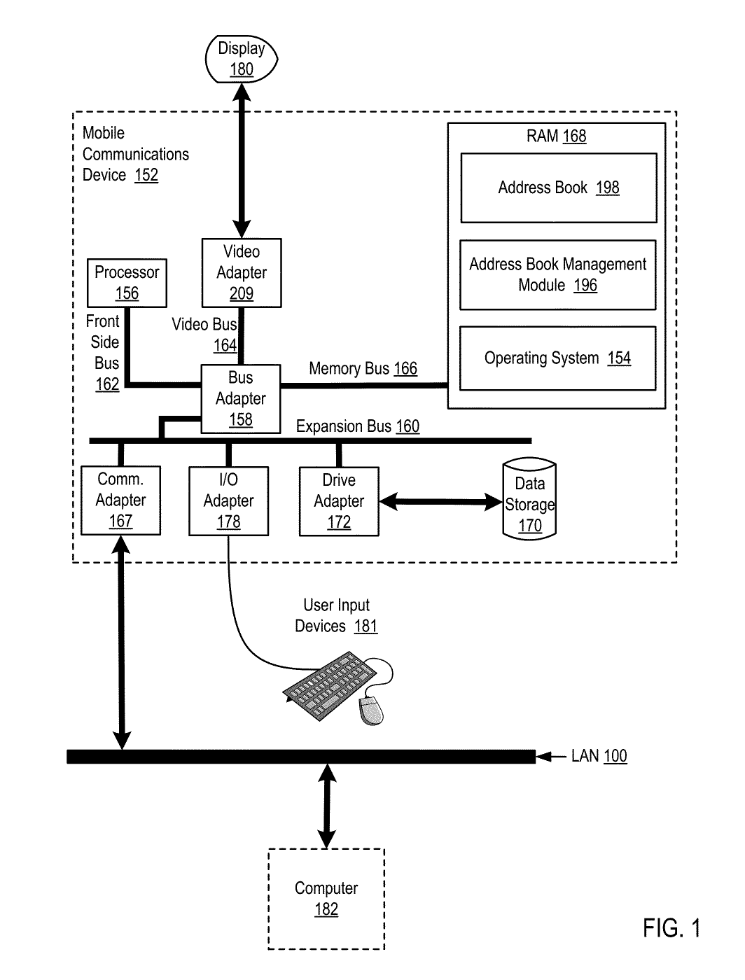

Example methods, apparatus, and products for time stamping entries in an address book of a mobile communications device in accordance with the present invention are described with reference to the accompanying drawings, beginning with FIG. 1. FIG. 1 sets forth a block diagram of automated computing machinery comprising an example mobile communications device (152) useful in time stamping entries in an address book according to embodiments of the present invention. The mobile communications device (152) of FIG. 1 includes at least one computer processor (156) or ‘CPU’ as well as random access memory (168) (RAM′) which is connected through a high speed memory bus (166) and bus adapter (158) to processor (156) and to other components of the mobile communications device (152).

Stored in RAM (168) is an address book management module (196), a module of computer program instructions for time stamping entries in an address book (198) according to embodiments of the present invention. The address book (198) may be embodied, for example, as a data structure stored in memory of the mobile communications device (152). The address book (198) depicted in FIG. 1 can include information useful in communicating with a plurality of contacts such as a phone number for a contact, a name for a contact, an email address for a contact, a physical address for a contact, and so on.

The address book management module (196) of FIG. 1 may be configured for time stamping entries in an address book (198) according to embodiments of the present invention by maintaining, for each entry stored in the address book (198) of the mobile communications device (152), age information for the entry. The age information for a particular entry may include information identifying the time at which the entry was added to the address book (198). The age information may be embodied as an absolute value such as a date or as a relative value such as the amount of time that the entry has been stored in the address book (198).

The address book management module (196) of FIG. 1 may be further configured for time stamping entries in an address book (198) according to embodiments of the present invention by initiating data communications with a device associated with the entry stored in the address book (198). Initiating data communications with a device associated with the entry stored in the address book (198) may be carried out, for example, by sending a data communications initiation message such as a text message to a device associated with a particular phone number stored in an entry in the address book (198). The data communications initiation message may include the age information for the entry.

In such an example, the age information may be utilized to determine whether the recipient device is the intended recipient. Consider an example in which the age information indicates that a particular phone number was added to the address book (198) of the mobile communications device (152) one year prior to the mobile communications device (152) initiating data communications with the recipient device. In such an example, if the recipient device has only been associated with the particular phone number for three months, it is possible that the particular phone number in the address book (198) of the mobile communications device (152) is stale and no longer represents a valid phone number for the contact. If the recipient device has been associated with the particular phone number for three years, however, it is likely that the particular phone number in the address book (198) of the mobile communications device (152) is still valid—as the current phone number for the recipient device is the phone number that was associated with the particular phone number at the time that the entry was added to the address book (198) of the mobile communications device (152).

Also stored in RAM (168) is an operating system (154). Operating systems useful in time stamping entries in an address book (198) of a mobile communications device (152) according to embodiments of the present invention include UNIX™, Linux™, Microsoft XP™, AIX™, IBM's i5/OS™, Apple™ iOS, Android™ OS, and others as will occur to those of skill in the art. The operating system (154), the address book management module (196), and the address book (198) in the example of FIG. 1 are shown in RAM (168), but many components of such software typically are stored in non-volatile memory also, such as, for example, on a disk drive (170).

The mobile communications device (152) of FIG. 1 includes disk drive adapter (172) coupled through expansion bus (160) and bus adapter (158) to processor (156) and other components of the mobile communications device (152). Disk drive adapter (172) connects non-volatile data storage to the mobile communications device (152) in the form of disk drive (170). Disk drive adapters useful in computers for time stamping entries in an address book (198) of a mobile communications device (152) according to embodiments of the present invention include Integrated Drive Electronics (IDE′) adapters, Small Computer System Interface (SCSI′) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example mobile communications device (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards, touchscreen displays, keypads, and so on. The example mobile communications device (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The example mobile communications device (152) of FIG. 1 includes a communications adapter (167) for data communications with other computers (182) and for data communications with a data communications network (100). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for time stamping entries in an address book (198) of a mobile communications device (152) according to embodiments of the present invention include modems for wired dial-up communications, Ethernet (IEEE 802.3) adapters for wired data communications network communications, adapters for communications over a telecommunications network, adapters for communications over a mobile communications network such as a long term evolution (‘LTE’) network, 802.11 adapters for wireless data communications network communications, and so on.

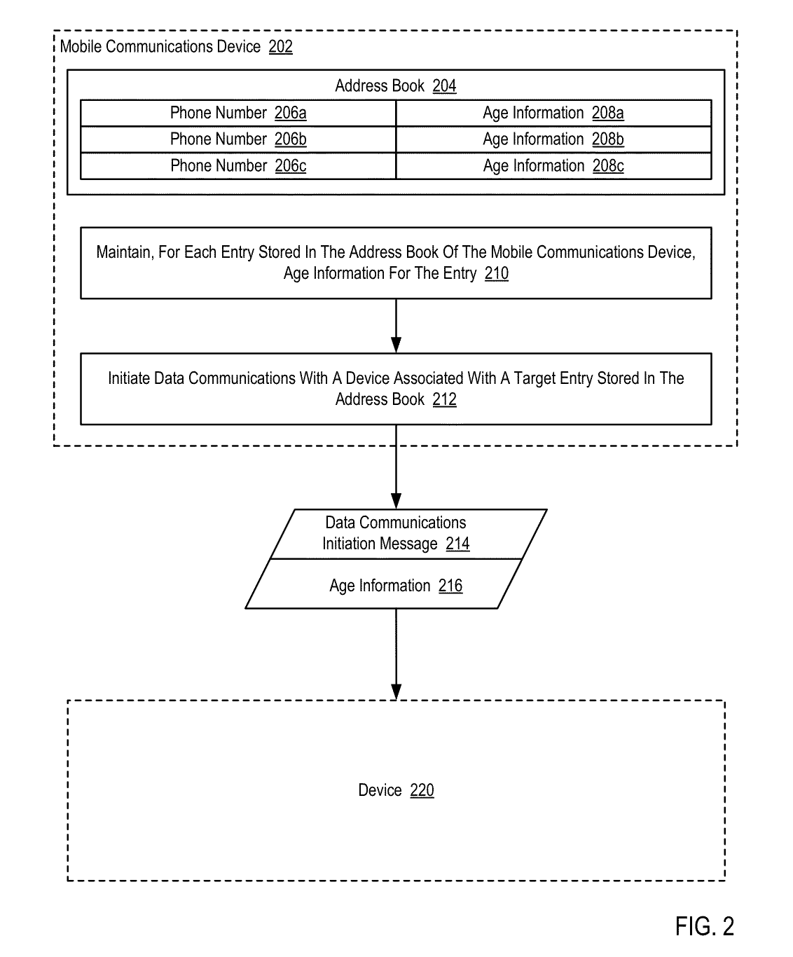

For further explanation, FIG. 2 sets forth a flow chart illustrating an example method for time stamping entries in an address book (204) of a mobile communications device (202) according to embodiments of the present invention. The mobile communications device (202) of FIG. 2 may be embodied, for example, as a smartphone configured for data communications over an IP network, data communications over a mobile communications network, data communications over a near-field communications link, and so on. The mobile communications device (202) depicted in FIG. 2 may include an address book (204). The address book (204) of FIG. 2 may be embodied, for example, as a data structure stored in memory of the mobile communications device (202). The address book (204) depicted in FIG. 2 can include information useful in communicating with a plurality of contacts such as a phone number for a contact, a name for a contact, an email address for a contact, a physical address for a contact, and so on.

The example method depicted in FIG. 2 includes maintaining (210), by the mobile communications device (202) for each entry stored in the address book (204) of the mobile communications device (202), age information (208a, 208b, 208c) associated with the entry. In the example method depicted in FIG. 2, the address book (204) is depicted as including a phone number (206a, 206b, 206c) in each entry as well as age information (208a, 208b, 208c) for each entry. In the example method of FIG. 2, age information (208a, 208b, 208c) for a particular entry may include information identifying the time at which the entry was added to the address book (204). The age information (208a, 208b, 208c) of FIG. 2 may be embodied as an absolute value such as a date or as a relative value such as the amount of time that the entry has been stored in the address book (204).

The example method depicted in FIG. 2 also includes initiating (212), by the mobile communications device (202), data communications with a device (220) associated with a target entry stored in the address book (204). In the example method of FIG. 2, initiating (212) data communications with a device (220) associated with the target entry stored in the address book (204) may be carried out, for example, by sending a data communications initiation message (214) such as a text message to a device (220) associated with a particular phone number (206a, 206b, 206c) associated with the target entry stored in the address book (204). In the example method of FIG. 2, the data communications initiation message (214) may include the age information (216) for the target entry stored in the address book (204).

In such an example, the age information (216) may be utilized to determine whether the recipient device (220) is the intended recipient. Consider an example in which the age information (216) indicates that a particular phone number (206a) was added to the address book (204) of the mobile communications device (202) one year prior to the mobile communications device (202) initiating (212) data communications with the recipient device (220). In such an example, if the recipient device (220) has only been associated with the particular phone number (206a) for three months, it is possible that the particular phone number (206a) in the address book (204) of the mobile communications device (202) is stale and no longer represents a valid phone number for the contact. If the recipient device (220) has been associated with the particular phone number (206a) for three years, however, it is likely that the particular phone number (206a) in the address book (204) of the mobile communications device (202) is still valid—as the current phone number for the recipient device (220) is the phone number that was associated with the particular phone number (206a) at the time that the entry was added to the address book (204) of the mobile communications device (202).

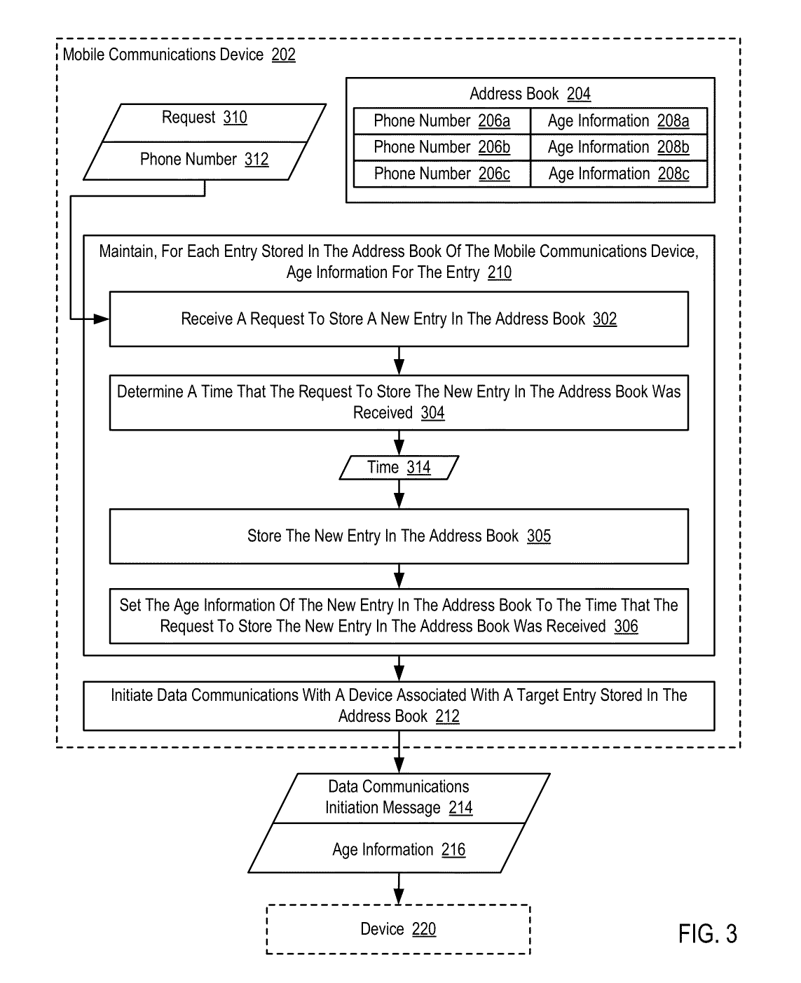

For further explanation, FIG. 3 sets forth a flow chart illustrating an additional example method for time stamping entries in an address book (204) of a mobile communications device (202) according to embodiments of the present invention. The example method depicted in FIG. 3 is similar to the example method depicted in FIG. 2, as it also includes maintaining (210), for each entry stored in the address book (204) of the mobile communications device (202), age information (208a, 208b, 208c) for the entry and initiating (212) data communications with a device (220) associated with the entry stored in the address book (204).

In the example method of FIG. 3, maintaining (210) age information (208a, 208b, 208c) for each entry stored in the address book (204) of the mobile communications device (202) can include receiving (302), by the mobile communications device (202), a request (310) to store a new entry in the address book (204). In the example method of FIG. 3, a request (310) to store a new entry in the address book (204) may be received (302), for example, via a text message from another mobile communications device that includes contact information for the new contact, via user input through a touch screen display and a GUI for adding contacts, and so on. In the example method of FIG. 3, the request (310) can include a phone number (312), as well as other information such as a name for the contact, an email address for the contact, a physical address for the contact, and so on.

In the example method of FIG. 3, maintaining (210) age information (208a, 208b, 208c) for each entry stored in the address book (204) of the mobile communications device (202) can also include determining (304), by the mobile communications device (202), a time (314) that the request (310) to store a new entry in the address book (204) was received (302). In the example method of FIG. 3, determining (304) a time (314) that the request (310) to store a new entry in the address book (204) was received (302) may be carried out, for example, by extracting a time and date from a clock maintained by the mobile communications device at the time that the request (310) to store a new entry in the address book (204) was received (302). Maintaining (210) age information (208a, 208b, 208c) for the entry can therefore also include the mobile communications device (202) storing (305) the new entry in the address book and setting (306) the age information for the entry to the time (314) that the request (310) to store a new entry in the address book (204) was received (302).

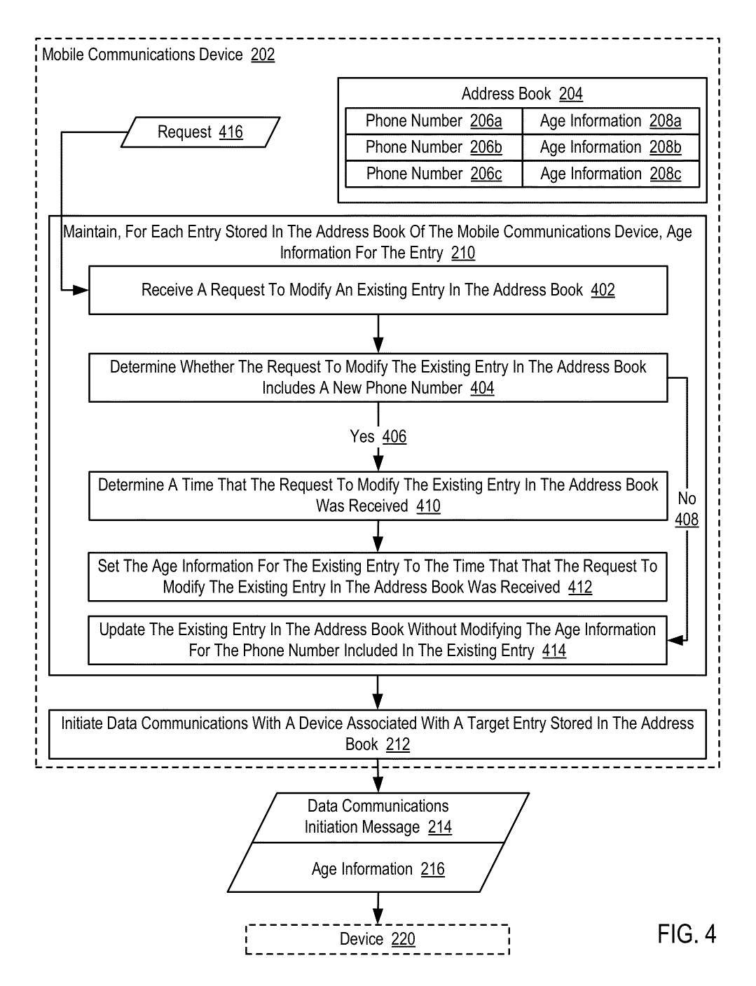

For further explanation, FIG. 4 sets forth a flow chart illustrating an additional example method for time stamping entries in an address book (204) of a mobile communications device (202) according to embodiments of the present invention. The example method depicted in FIG. 4 is similar to the example method depicted in FIG. 2, as it also includes maintaining (210), for each entry stored in the address book (204) of the mobile communications device (202), age information (208a, 208b, 208c) for the entry and initiating (212) data communications with a device (220) associated with the entry stored in the address book (204).

In the example method of FIG. 4, maintaining (210) age information (208a, 208b, 208c) for each entry stored in the address book (204) of the mobile communications device (202) can include receiving (402), by the mobile communications device (202), a request (416) to modify an existing entry in the address book (204). In the example method of FIG. 4, the request (416) to modify an existing entry in the address book (204) may be generated, for example, by a user of the mobile communications device (202) accessing the address book (204) through a GUI and modifying an entry in the address book (204). Readers will appreciate that the user of the mobile communications device (202) may modify an entry in the address book (204) by changing the name of a contact in the address book (204), changing the email address for a contact in the address book (204), changing the phone number for a contact in the address book (204), and so on.

In the example method of FIG. 4, maintaining (210) age information (208a, 208b, 208c) for each entry stored in the address book (204) of the mobile communications device (202) can also include determining (404), by the mobile communications device (202), whether the request (416) to modify the existing entry in the address book (204) includes a new phone number. In the example method of FIG. 4, changing the name of a contact in the address book (204), changing the email address for a contact in the address book (204), or performing other modifications that do not include modifying a phone number may have no impact on the age information (208a, 208b, 208c) that is maintained by the mobile communications device (202), as updating these fields does not necessarily indicate that the existing entry includes a phone number that is no longer associated with the contact identified by the existing entry. As such, the mobile communications device (202) may determine (404) whether the request (416) to modify the existing entry in the address book (204) includes a new phone number in order to determine whether the age information (208a, 208b, 208c) that is maintained by the mobile communications device (202) needs to be updated in response to such a modification.

In the example method of FIG. 4, maintaining (210) age information (208a, 208b, 208c) for each entry stored in the address book (204) of the mobile communications device (202) can also include determining (410), by the mobile communications device (202), a time that the request (416) to modify the existing entry in the address book (204) was received. Determining (410) a time that the request (416) to modify the existing entry in the address book (204) was received can be carried out in response to affirmatively (406) determining that the request (416) to modify the existing entry in the address book (204) includes the new phone number. In the example method of FIG. 4, determining (410) a time that the request (416) to modify the existing entry in the address book (204) was received can be carried out, for example, by extracting a time and date from a clock maintained by the mobile communications device at the time that the entry (310) for the new contact was received (302). In the example method of FIG. 4 maintaining (210) age information (208a, 208b, 208c) for the phone number (206a, 206b, 206c) can therefore also include setting (412), by the mobile communications device (202), the age information for the existing entry to the time that that the request (416) to modify the existing entry in the address book (204) was received.

In the example method of FIG. 4, maintaining (210) age information (208a, 208b, 208c) for each entry stored in the address book (204) of the mobile communications device (202) can also include updating (414) the existing entry in the address book (204) without modifying the age information for the phone number included in the existing entry. In the example method of FIG. 4, updating (414) the existing entry in the address book (204) without modifying the age information for the phone number included in the existing entry may be carried out in response to determining that the request (416) to modify the existing entry in the address book (204) does not (408) include a new phone number.

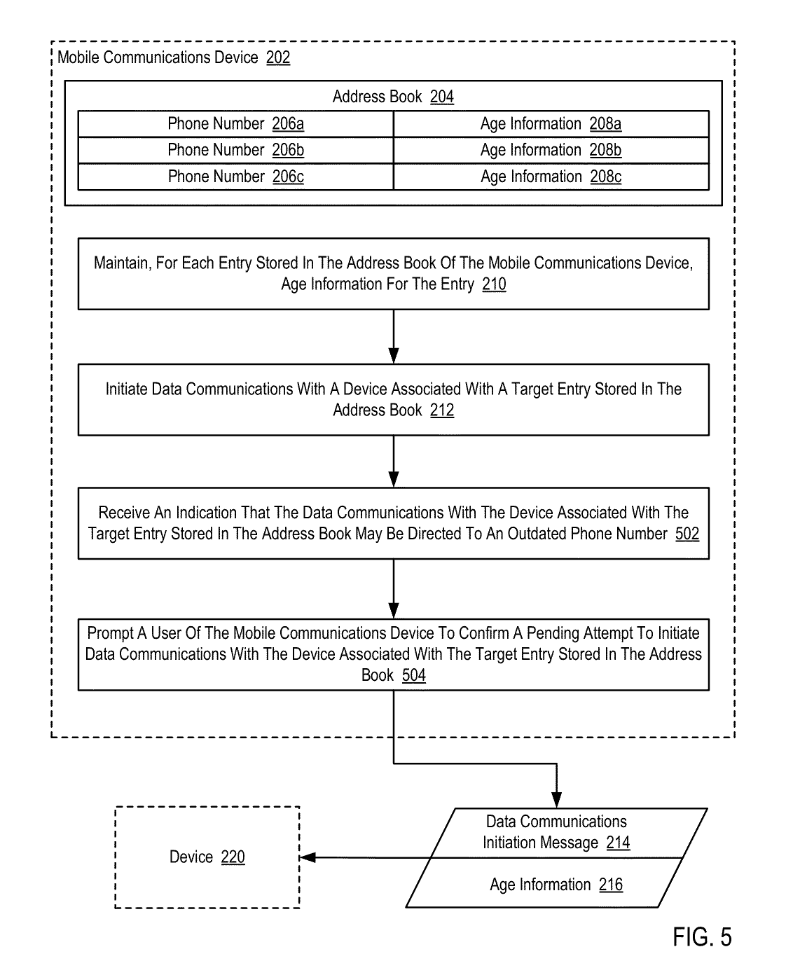

For further explanation, FIG. 5 sets forth a flow chart illustrating an additional example method for time stamping entries in an address book (204) of a mobile communications device (202) according to embodiments of the present invention. The example method depicted in FIG. 5 is similar to the example method depicted in FIG. 2, as it also includes maintaining (210), for each entry stored in the address book (204) of the mobile communications device (202), age information (208a, 208b, 208c) for the entry and initiating (212) data communications with a device (220) associated with the entry stored in the address book (204).

The example method of FIG. 5 can also include receiving (502), by the mobile communications device (202), an indication that the data communications with the device (220) associated with the phone number stored in the address book (204) may be directed to an outdated phone number. In the example method depicted in FIG. 5, an indication that the data communications with the device (220) associated with the phone number stored in the address book (204) may be directed to an outdated phone number can be received (502), for example, from a mobile communications service provider. In such an example, the service provider may maintain information identifying when the account that is associated with the phone number was created. The information identifying when the account that is associated with the phone number was created may be compared to the age information (216) contained in the data communications initiation message (214). In such an example, when the age information (216) contained in the data communications initiation message (214) predates the date on which the account that is associated with the phone number was created, the service provider may send a message to the mobile communications device (202) indicating that the phone number stored in the address book (204) may be directed to an outdated phone number.

The example method of FIG. 5 can also include prompting (504), by the mobile communications device (202), a user of the mobile communications device (202) to confirm a pending attempt to initiate data communications with the device (220) associated with the phone number stored in the address book (204). In the example method of FIG. 5, prompting (504) a user of the mobile communications device (202) to confirm a pending attempt to initiate data communications with the device (220) associated with the phone number stored in the address book (204) may be carried out by presenting a prompt, for example, on a display screen of the mobile communications device (202).

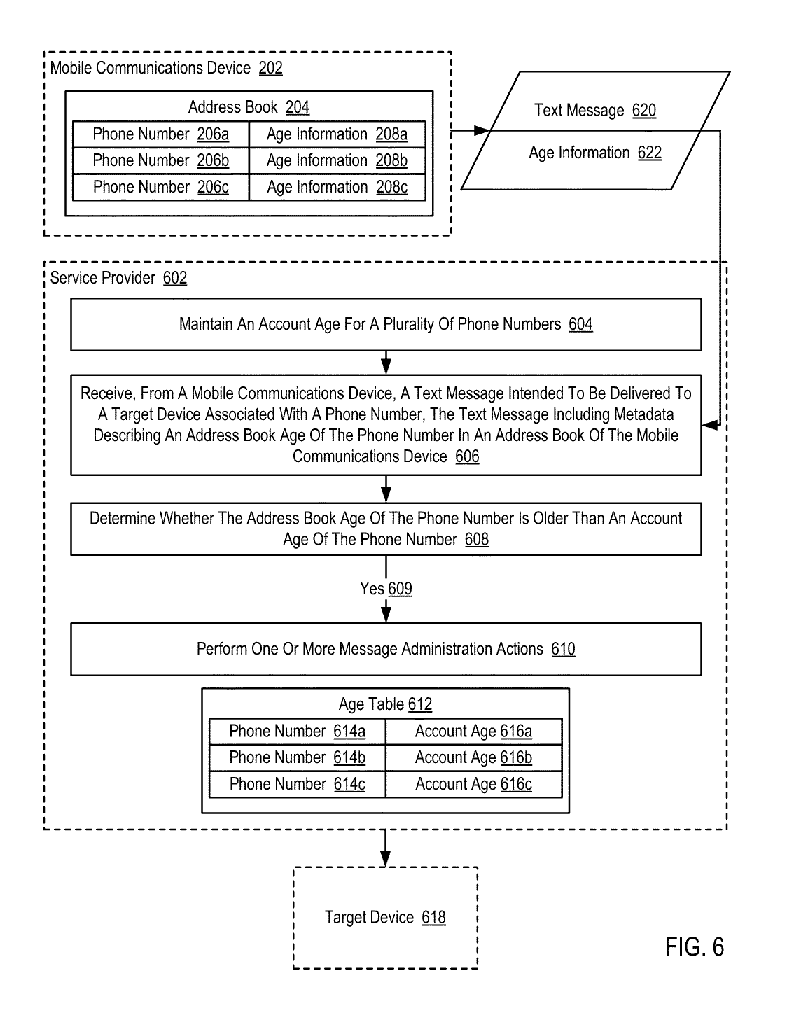

For further explanation, FIG. 6 sets forth a flow chart illustrating an example method for administering text message communications according to embodiments of the present invention. The method depicted in FIG. 6 is carried out, at least in part, by a service provider (602). The service provider (602) may be embodied, for example, as a telecommunications service provider that provides communications services such as telephone services, multimedia messaging services, and other services through a mobile communications network. The service provider (602) depicted in FIG. 6 may be configured for administering text message communications according to embodiments of the present invention through the use of special purpose computer program instructions executing on computer hardware that is managed by the service provider (602).

The example method of FIG. 6 includes maintaining (604), by a service provider (602), an account age (616a, 616b, 616c) for a plurality of phone numbers (614a, 614b, 614c). In the example method of FIG. 6, the account age (616a, 616b, 616c) for a particular of phone number (614a, 614b, 614c) may represent the date on which a particular phone number (614a, 614b, 614c) became associated with a particular customer. The account age (616a, 616b, 616c) for a particular phone number (614a, 614b, 614c) may be embodied, for example, as an absolute value such as a date, as a relative value (e.g., 200 days ago), and so on. In the example method of FIG. 6, an account age (616a, 616b, 616c) for a plurality of phone numbers (614a, 614b, 614c) may be maintained (604) by the service provider (602) in a database, table, or other data repository.

The example method of FIG. 6 also includes receiving (606), by the service provider (602) from a mobile communications device (202), a text message (620) intended to be delivered to a target device (618) associated with a phone number. In the example method depicted in FIG. 6, the text message (620) includes age information (622) describing an address book age of the phone number in an address book (204) of the mobile communications device (202). Such age information (622) may be embodied, for example, as metadata contained in a header of the text message (620). Although the example described herein refers to a text message (620), readers will appreciate that such a text message (620) may be embodied as a Short Message Service (‘SMS’) message, Multimedia Messaging Service (‘MMS’) message, Enhanced Messaging Service (EMS′) message, or other messaging format for use by mobile communications devices.

The example method of FIG. 6 also includes determining (608), by the service provider (602), whether the address book age of the phone number is older than an account age (616a, 616b, 616c) of the phone number (614a, 614b, 614c). In the example method of FIG. 6, determining (608) whether the address book age of the phone number is older than an account age (616a, 616b, 616c) of the phone number (614a, 614b, 614c) may be carried out, for example, by comparing the account age (616a, 616b, 616c) of the phone number (614a, 614b, 614c) to the age information (622) included in the text message (620).

The example method of FIG. 6 also includes performing (610), by the service provider (602), one or more message administration actions. In the example method of FIG. 6, a message administration action may include an action that impacts whether the text message (620) will be delivered to the recipient identified by a particular phone number. In the example method of FIG. 6, performing (610) one or more message administration actions is carried out in response to affirmatively (609) determining that the address book age information (622) of the phone number is older than the account age (616a, 616b, 616c) of the phone number (614a, 614b, 614c). In such an example, because the address book age information (622) of the phone number is older than the account age (616a, 616b, 616c) of the phone number (614a, 614b, 614c), it is possible that the phone number (206a, 206b, 206c) in the address book (204) of the mobile communications device (202) is out of date—given that the phone number (206a, 206b, 206c) was added to the address book (204) of the mobile communications device (202) prior to the service provider (602) creating the account that is currently associated with the phone number. In such an example, the service provider (602) may desire to take message administration action such as blocking the delivery of the text message (620).

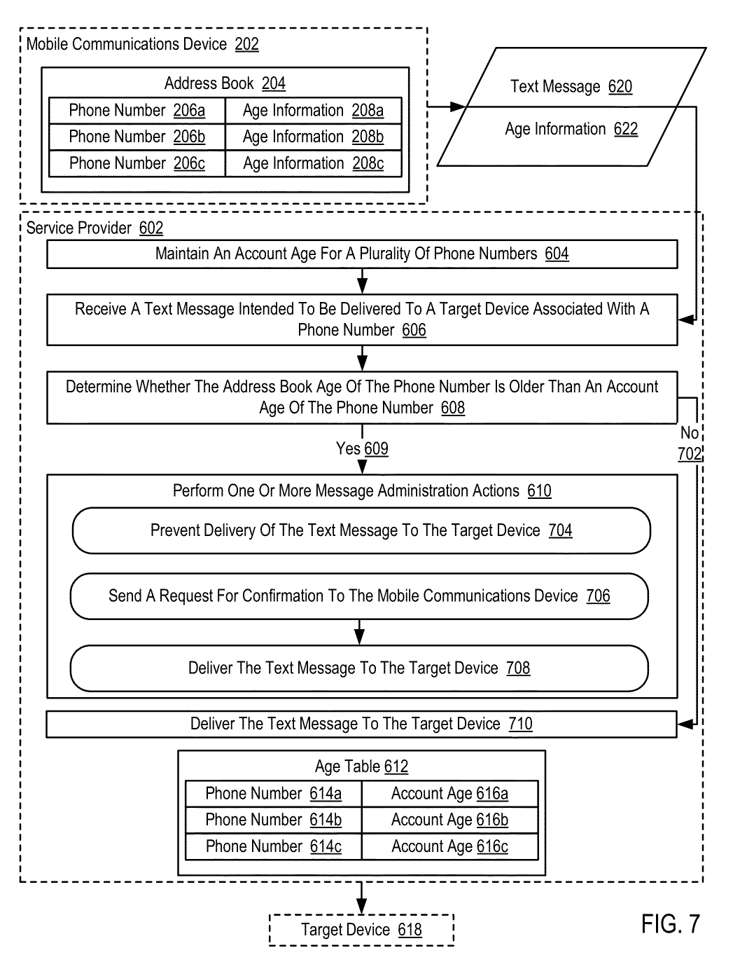

For further explanation, FIG. 7 sets forth a flow chart illustrating an additional example method for administering text message communications according to embodiments of the present invention. The example method depicted in FIG. 7 is similar to the example method depicted in FIG. 6, as it also includes maintaining (604) an account age (616a, 616b, 616c) for a plurality of phone numbers (614a, 614b, 614c), receiving (606) a text message (620) intended to be delivered to a target device (618) associated with a phone number, determining (608) whether the address book age of the phone number is older than an account age (616a, 616b, 616c) of the phone number (614a, 614b, 614c), and performing (610) one or more message administration actions.

In the example method depicted in FIG. 7, performing (610) one or more message administration actions can include sending (706) a request for confirmation to the mobile communications device (202). In the example method of FIG. 7, the request for confirmation that is sent (706) to the mobile communications device (202) may include an identification of the target device (618). The identification of the target device (618) may include, for example, the name of the account holder of the phone number for target device (618), the date that the target device (618) became associated with the phone number for the target device, and so on. In such an example, sending (706) a request for confirmation to the mobile communications device (202) may result in the user of the mobile communications device (202) being prompted to continue or abort delivery of the text message (620) from the mobile communications device (202) to the target device (618).

In the example method depicted in FIG. 7, performing (610) one or more message administration actions can include delivering (708), by the service provider (602), the text message (620) to the target device (618). Delivering (708) the text message (620) to the target device (618) may be carried out in response to receiving a confirmation message from the mobile communications device (202). In the example method of FIG. 7, a confirmation message from the mobile communications device (202) may be sent to the service provider (602) in response to the user of the mobile communications device (202) indicating that the user of the mobile communications device (202) wishes to deliver the text message (620) to the target device (618). In the example method depicted in FIG. 7, performing (610) one or more message administration actions can alternatively include preventing (704), by the service provider (602), delivery of the text message (620) to the target device (618).

The example method of FIG. 7 also includes delivering (710), by the service provider (602), the text message (620) to the target device (618). In the example method depicted in FIG. 7, delivering (710) the text message (620) to the target device (618) may be carried out in response to determining that the address book age information (622) of the phone number is not (702) older than the account age (616a, 616b, 616c) of the phone number (614a, 614b, 614c).

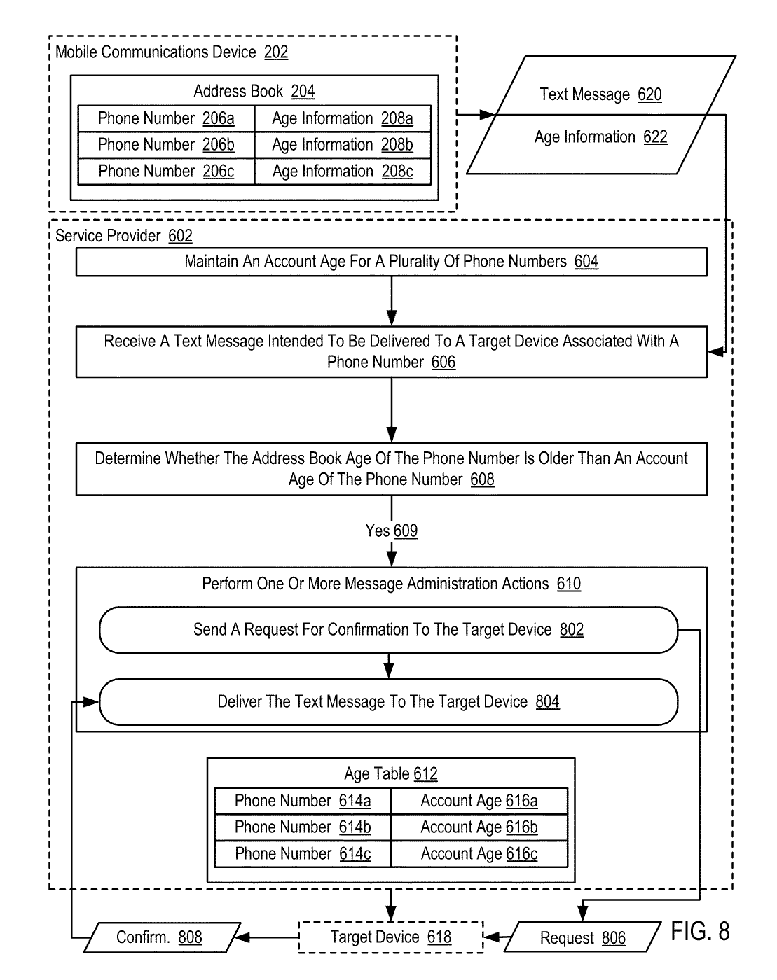

For further explanation, FIG. 8 sets forth a flow chart illustrating an additional example method for administering text message communications according to embodiments of the present invention. The example method depicted in FIG. 8 is similar to the example method depicted in FIG. 6, as it also includes maintaining (604) an account age (616a, 616b, 616c) for a plurality of phone numbers (614a, 614b, 614c), receiving (606) a text message (620) intended to be delivered to a target device (618) associated with a phone number, determining (608) whether the address book age of the phone number is older than an account age (616a, 616b, 616c) of the phone number (614a, 614b, 614c), and performing (610) one or more message administration actions.

In the example method depicted in FIG. 8, performing (610) one or more message administration actions can include sending (802) a request (806) for confirmation to the target device (618). In the example method of FIG. 8, the request (806) for confirmation that is sent (802) to the target device (618) may include an identification of the mobile communications device (202) that is attempting to send a text message (620) to the target device (618). The identification of the mobile communications device (202) that is attempting to send a text message (620) to the target device (618) may include, for example, the phone number of the mobile communications device (202), the name of the account holder of the phone number for the mobile communications device (202), and so on. In such an example, sending (802) a request (806) for confirmation to the target device (618) may result in the user of the target device (618) being prompted to accept or decline delivery of the text message (620) from the mobile communications device (202).

In the example method depicted in FIG. 8, performing (610) one or more message administration actions can also include delivering (804), by the service provider (602), the text message (620) to the target device (618). Delivering (804) the text message (620) to the target device (618) can be carried out in response to receiving a confirmation (808) message from the target device (618). In the example method of FIG. 8, a confirmation (808) message from the target device (618) may be sent to the service provider (602) in response to the user of the target device (618) indicating that the user of the target device (618) wishes to accept delivery of the text message (620) from the mobile communications device (202).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of time stamping entries in an address book of a mobile communications device, the method comprising:
maintaining, by the mobile communications device for each entry stored in the address book of the mobile communications device, age information for the entry; and
initiating, by the mobile communications device, data communications with a device associated with a target entry stored in the address book, wherein the data communications include the age information for the target entry.

2. The method of claim 1 wherein maintaining age information for the entry further comprises:
receiving, by the mobile communications device, a request to store a new entry in the address book;
determining, by the mobile communications device, a time that the request to store the new entry in the address book was received;
storing, by the mobile communications device, the new entry in the address book; and
setting, by the mobile communications device, the age information of the new entry in the address book to the time that the request to store the new entry in the address book was received.

3. The method of claim 1 wherein maintaining age information for the entry further comprises:
receiving, by the mobile communications device, a request to modify an existing entry in the address book;
determining, by the mobile communications device, whether the request to modify the existing entry in the address book includes a new phone number; and
responsive to determining that the request to modify the existing entry in the address book includes the new phone number:
determining, by the mobile communications device, a time that the request to modify the existing entry in the address book was received; and
setting, by the mobile communications device, the age information for the existing entry to the time that that the request to modify the existing entry in the address book was received.

4. The method of claim 3 wherein maintaining age information for the entry further comprises, responsive to determining that the request to modify the existing entry in the address book does not include a new phone number, updating the existing entry in the address book without modifying the age information for the existing entry.

5. The method of claim 1 further comprising receiving, by the mobile communications device, an indication that the data communications with the device associated with the target entry stored in the address book may be directed to an outdated phone number.

6. The method of claim 1 further comprising prompting, by the mobile communications device, a user of the mobile communications device to confirm a pending attempt to initiate data communications with the device associated with the target entry stored in the address book.

7. A mobile communications device for time stamping entries in an address book, the mobile communications device comprising a computer processor, a computer memory operatively coupled to the computer processor, the computer memory having disposed within it computer program instructions that, when executed by the computer processor, cause the mobile communications device to carry out the steps of:
maintaining, for each entry stored in the address book of the mobile communications device, age information for the entry; and
initiating data communications with a device associated with a target entry stored in the address book, wherein the data communications include the age information for the target entry.

8. The mobile communications device of claim 7 wherein maintaining age information for the entry further comprises:
receiving a request to store a new entry in the address book;
determining a time that the request to store the new entry in the address book was received;
storing the new entry in the address book; and
setting the age information of the new entry in the address book to the time that the request to store the new entry in the address book was received.

9. The mobile communications device of claim 7 wherein maintaining age information for the entry further comprises:
receiving a request to modify an existing entry in the address book;
determining whether the request to modify the existing entry in the address book includes a new phone number; and
responsive to determining that the request to modify the existing entry in the address book includes the new phone number:
determining a time that the request to modify the existing entry in the address book was received; and
setting the age information for the existing entry to the time that that the request to modify the existing entry in the address book was received.

10. The mobile communications device of claim 9 wherein maintaining age information for the entry further comprises, responsive to determining that the request to modify the existing entry in the address book does not include a new phone number, updating the existing entry in the address book without modifying the age information for the existing entry.

11. The mobile communications device of claim 7 further comprising computer program instructions that, when executed by the computer processor, cause the mobile communications device to carry out the step of receiving an indication that the data communications with the device associated with the target entry stored in the address book may be directed to an outdated phone number.

12. The mobile communications device of claim 7 further comprising computer program instructions that, when executed by the computer processor, cause the mobile communications device to carry out the step of prompting a user of the mobile communications device to confirm a pending attempt to initiate data communications with the device associated with the target entry stored in the address book.

13. A method of administering text message communications, the method comprising:
maintaining, by a service provider, an account age for a plurality of phone numbers;
receiving, by the service provider from a mobile communications device, a text message intended to be delivered to a target device associated with a phone number, the text message including metadata describing an address book age of the phone number in an address book of the mobile communications device;
determining, by the service provider, whether the address book age of the phone number is older than an account age of the phone number; and
responsive to determining that the address book age information of the phone number is older than the account age of the phone number, performing, by the service provider, one or more message administration actions.

14. The method of claim 13 further comprising, responsive to determining that the address book age information of the phone number is not older than the account age of the phone number, delivering, by the service provider, the text message to the target device.

15. The method of claim 13 wherein performing, by the service provider, one or more message administration actions further comprises:
sending a request for confirmation to the mobile communications device; and
responsive to receiving a confirmation message from the mobile communications device, delivering, by the service provider, the text message to the target device.

16. The method of claim 13 wherein performing, by the service provider, one or more message administration actions further comprises:
sending a request for confirmation to the target device; and
responsive to receiving a confirmation message from the target device, delivering, by the service provider, the text message to the target device.

17. The method of claim 13 wherein performing, by the service provider, one or more message administration actions further comprises preventing, by the service provider, delivery of the text message to the target device.
